(19) United States
(12) Patent Application Publication
(10) Pub. No.: US 2019/0371134 A1
(43) Pub. Date: Dec. 5, 2019

(54) SELF-CHECKOUT SYSTEM, METHOD THEREOF AND DEVICE THEREFOR

(71) Applicant: Industrial Technology Research Institute, Hsinchu (TW)

(72) Inventors: Ming-Yen Chen, Pingtung County (TW); Chang-Hong Lin, Hsinchu County (TW); Hsin-Yeh Yang, Taichung City (TW); Po-Hsuan Hsiao, Nantou County (TW)

(73) Assignee: Industrial Technology Research Institute, Hsinchu (TW)

(21) Appl. No.: 16/425,961

(22) Filed: May 30, 2019

Related U.S. Application Data
(60) Provisional application No. 62/679,036, filed on Jun. 1, 2018.

(30) Foreign Application Priority Data
Dec. 22, 2018 (TW) 107146687

(51) Int. Cl. G07G 1/00; G06Q 20/18; G06Q 20/20; G06K 9/00; G06K 9/46; G06K 9/62

(52) U.S. Cl. CPC G07G 1/0036; G06Q 20/18; G06Q 20/206; G06Q 20/208; G06K 9/6215; G06K 9/00369; G06K 9/00771; G06K 9/46; G06K 9/00342

(57) ABSTRACT

A self-checkout system capable of product identification and customer abnormal behavior detection, a method thereof and a device therefor are provided herein. The self-checkout system includes a product identification device and a customer abnormal behavior detection device. The product identification device is configured to perform a product identification, in which whether products are correctly placed on a platform and whether the identification can be completed are determined. The customer abnormal behavior detection device is configured to detect whether a customer has an abnormal checkout behavior.

### CROSS-REFERENCE TO RELATED APPLICATION

This application claims the priority benefits of U.S. provisional application No. 62/679,036, filed on Jun. 1, 2018, and Taiwan application no. 107146687, filed on Dec. 22, 2018. The entirety of each of the above-mentioned patent applications is hereby incorporated by reference herein and made a part of this specification.

### TECHNICAL FIELD

The present disclosure proposes a self-checkout system, a method thereof and a device therefor.

### BACKGROUND

At present, there are two main types of self-checkout systems, namely, a manual barcode scanning based self-checkout system and a computer vision based self-checkout system. The manual barcode scanning based self-checkout system reduces the incidence of customer theft by determining whether the weight of products is abnormal, recording images for post-analysis and sending staffs to conduct regular inspections. The computer vision based self-checkout system can only identify products on a platform and cannot detect whether the customer really did put all the products on the platform and settle accounts accordingly. When the products cannot be identified as expected, staffs would be conducted for troubleshooting manually.

### SUMMARY

The present disclosure provides a self-checkout system, a method thereof and a device therefor.

The self-checkout system in one of the exemplary examples of the disclosure includes a platform, a product identification device and a customer abnormal behavior detection device. The platform is configured to place at least one product. The product identification device is configured to perform a product identification on the at least one product placed on the platform. The customer abnormal behavior detection device is configured to perform an abnormal checkout behavior detection based on a customer image captured in front of the platform to obtain an abnormal behavior detection result. When the abnormal behavior detection result is verified as an abnormal behavior, an abnormal behavior notification is sent to thereby adjust the abnormal behavior.

The self-checkout method in one of the exemplary examples of the present disclosure includes: performing a product identification on at least one product placed on a platform; capturing a customer image; and performing an abnormal checkout behavior detection based on the customer image, and obtaining an abnormal behavior detection result based on the customer image. When determining that the abnormal behavior detection result is an abnormal behavior, an abnormal behavior notification is sent to thereby adjust the abnormal behavior.

The self-checkout device in one of the exemplary examples of the disclosure includes a platform, an image capturing device and a processor. The platform is configured to place at least one product. The image capturing device is used for capturing a platform image and a customer image. The processor is configured to perform a product identification process and/or an abnormal checkout behavior detection process on the at least one product placed on the platform. The product identification process includes obtaining an identification result based on the platform image. When the identification result is not obtained, a prompt notification is sent for adjusting a placement manner of the at least one product on the platform. The abnormal checkout behavior detection process performs an abnormal checkout behavior detection based on the customer image to obtain an abnormal behavior detection result. When the abnormal behavior detection result is verified as an abnormal behavior, an abnormal behavior notification is sent to thereby adjust the abnormal behavior.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic structural diagram illustrating a self-checkout system in one of the embodiments of the disclosure.

FIG. 1B is a schematic diagram illustrating a computer vision based self-checkout system.

FIG. 2 is a schematic structural diagram illustrating a self-checkout system in one of the embodiments of the disclosure.

FIG. 3A is a schematic diagram illustrating a customer abnormal behavior detection process in an embodiment of the disclosure.

FIGS. 3B to 3D are schematic diagrams respectively illustrating a customer posture identification process performed based on a customer image in exemplary examples of the disclosure.

FIG. 4A and FIG. 4B are schematic diagrams illustrating a behavior/posture identification process and a handheld object identification process in exemplary examples of the disclosure.

FIG. 5 is a schematic diagram illustrating a computer vision based product identification process according to an embodiment of the disclosure.

FIGS. 6A and 6B are schematic diagrams respectively illustrating a product object segmentation process according to an embodiment of the disclosure.

FIG. 6C is a schematic diagram illustrating a product feature identification according to an embodiment of the disclosure.

FIG. 7A is a schematic diagram illustrating a product classification process according to an embodiment of the disclosure.

FIG. 7B is a schematic diagram illustrating a classification result confidence value table according to an embodiment of the disclosure.

FIG. 7C is a schematic diagram illustrating a product facing direction determination process for determining a facing direction of the product according to an embodiment of the disclosure.

FIG. 7D is a schematic diagram illustrating a product connection detection according to an embodiment of the disclosure.

FIG. 7E is a schematic diagram illustrating how the customer is prompted to adjust a placement manner of the products according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The self-checkout system in one of the exemplary examples of the disclosure includes a product identification device and a customer abnormal behavior detection device. The product identification device is configured to perform a product identification, in which whether products are correctly placed on a platform and whether the identification can be completed are determined. A product category detection may use a weight and/or a depth detection to help identifying the products. The customer abnormal behavior detection device is configured to detect whether a customer has an abnormal checkout behavior. Based on the above, other than identifying the abnormal checkout behavior, an embodiment of the disclosure can also perform skeleton and/or behavior pattern identification and a handheld product detection. The customer abnormal behavior detection device may determine whether the customer is still carrying products after excluding personal belongs such as a leather bag, a cell phone and the like based on the result of the keypoint detection identification, behavior pattern identification and/or handheld product detection. Moreover, in another alternative embodiment, the self-checkout system and the method thereof can automatically identify names and quantities of the products purchasing by the customer. Especially, whether a placement manner of the products can show enough features of the products within a viewing angle of a camera may be determined, and the customer may be prompted to turn over or separate the products in order to complete identifying the products.

The self-checkout system and the method thereof proposed by the disclosure are described below with reference to different exemplary examples, but not limited thereto.

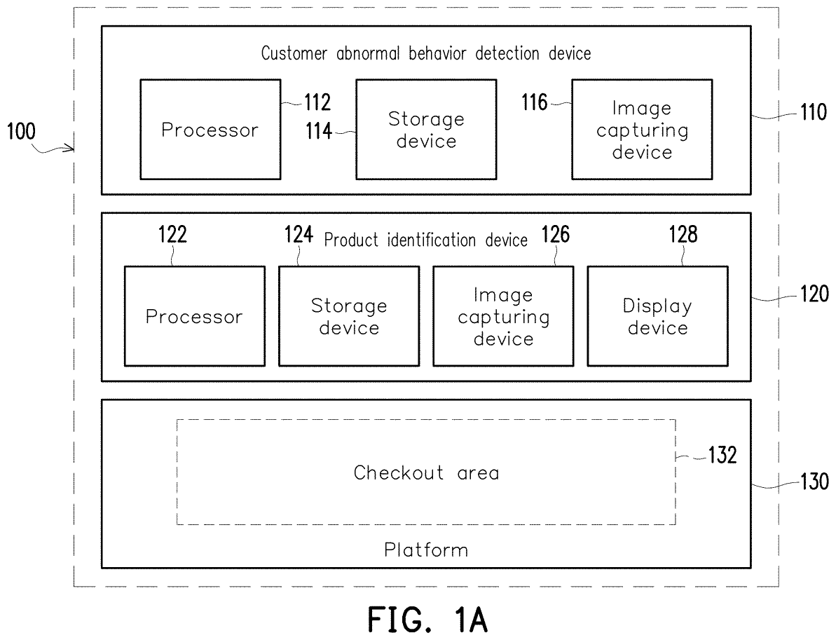

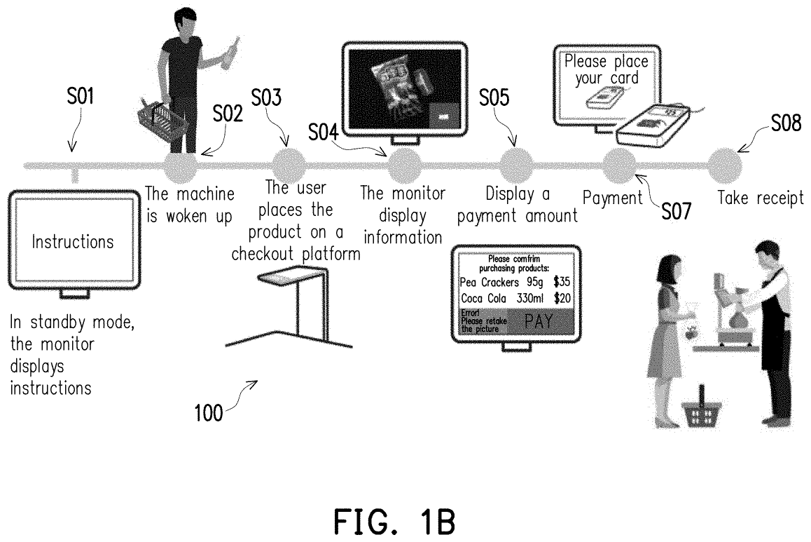

With reference to FIG. 1A, FIG. 1A is a schematic structural diagram illustrating a self-checkout system in one of the embodiments of the disclosure. In this embodiment, a self-checkout system 100 includes a customer abnormal behavior detection device 110, a product identification device 120 and a platform 130. A clearly visible checkout area 132 is included on the platform 130 for the customer to place the products.

The customer abnormal behavior detection device 110 and the product identification device 120 may be interconnected or may operate independently in a separate manner. In an embodiment, the customer abnormal behavior detection device 110 and the product identification device 120 can share elements with each other. In an embodiment of the disclosure, the product identification device 120 can operate after the operation of the customer abnormal behavior detection device 110. In this way, after all the products are placed on the platform 130 by the customer, whether the customer is still carrying the products may be verified before a checkout calculation is performed. Other than that, the customer abnormal behavior detection device 110 and the product identification device 120 may also operate at the same time based on demands.

In one exemplary example, the customer abnormal behavior detection device 110 may include a processor 112, a storage device 114 and an image capturing device 116. The processor 112 may be a general-purpose computer central processing unit (CPU) that provides various functions by reading and executing programs or commands stored in the storage device. A part or all of the functions of the processor 112 may be replaced by dedicated circuits such as Application Specific Integrated Circuit (ASIC). The storage device 114 may be a nonvolatile memory such as a hard disk, a solid-state hard disk or a flash memory, and may be used to store captured images. The storage device 114 may also be used to store program software or an instruction set required for performing a customer abnormal behavior detection by the customer abnormal behavior detection device 110. The image capturing device 116 is, for example, a camera or a camcorder, and used to take pictures in order to capture an image of the customer (customer image) at checkout.

The program software required for the customer abnormal behavior detection includes, for example, a real-time keypoint detection program, a behavior identification program, a handheld object identification program, and the like. In one alternative embodiment, the storage device may also store a plurality of databases, and these databases are used to store a plurality of checkout behavior data and deep learning data. In another alternative embodiment, the plurality or some of said databases may be stored in a remote host server or a cloud server. Further, the customer abnormal behavior detection device 110 may include a network access device that can access the databases via a network or download the databases from the remote host server or the cloud server.

In one exemplary example, the product identification device 120 may include a processor 122, a storage device 124, an image capturing device 126 and/or a display device 128. The processor 122 may be a general-purpose computer central processing unit (CPU) that provides various functions by reading and executing programs or commands stored in the storage device. A part or all of the functions of the processor 122 may be replaced by dedicated circuits such as Application Specific Integrated Circuit (ASIC). The storage device 124 may be a nonvolatile memory such as a hard disk, a solid-state hard disk, a flash memory, and the like. The storage device 124 is configured to store programs for the operation of the product identification device 120, including, for example, a part or all of a product object segmentation program, a product feature identification program, a product placement determination program, a product facing direction determination program and a product connection detection program. The image capturing device 126 is, for example, a camera or a camcorder, and used to take pictures in the checkout area in order to generate an image within the checkout area 132 on the platform 130 (platform image).

In one alternative embodiment, the storage device 124 may also store a plurality of databases, and these databases are used to store a plurality of checkout behavior data and deep learning data. In another alternative embodiment, the plurality or some of said databases may be stored in a remote host server or a cloud server. Further, the product identification device 120 may include a network access device that can access the databases via a network or download the databases from the remote host server or the cloud server. The storage device 124 may also include one database for storing a plurality of product data and deep learning data.

In addition, the product identification device 120 may also be disposed with the display device 128, such as a monitor or a projector, which is used to display a customer interface or display a prompt message. The display device 128 may be a touch screen used to provide the customer interface for interaction with the customer.

In another embodiment, the display device 128 may also be a different device independent from the product identification device 120, or a display of other devices, instead of being limited by this embodiment. The product identification device 120 may also be disposed with a sound playback device, such as a speaker, which is used to play sounds, such as music, a prompt sound or other description. The display device 128 and the sound playback device may be used simultaneously or alternatively.

A practical application exemplary example of the self-checkout system according to an embodiment of the disclosure may refer to FIG. 1B. FIG. 1B illustrates a process for a computer vision based self-checkout system. In this computer vision based self-checkout system, the entire self-checkout process may be completed by the self-checkout system 100 and/or other peripheral equipment based on the following process.

With reference to FIG. 1B, in step S01, the display device of the self-checkout system 100 in a standby mode performs, for example, a standby operation (e.g., displaying instruction for steps of use). When the customer approaches, the self-checkout system 100 is woken up (step S02). Next, in step S03, the customer places a plurality of products on the platform, and the self-checkout system 100 uses the image capturing device 126 of the product identification device 120 to identify the products. In an embodiment, a weight detection and/or a depth detection may be used to help identifying the products. Next, in step S04, corresponding information is displayed on the display device (information regarding multiple products may be displayed at the same time). Afterwards, in step S05, an amount of a payment is displayed. Then, the customer makes the payment in step S07, and obtains a receipt in step S08.

The computer vision based product identification technology used in the computer vision based self-checkout system can detect features of the products on the platform through a computer vision and deep learning technology and can identify the names and the quantities of the products purchasing by the customer through a joint decision based on features of the products including shapes, colors, texts, trademarks, barcodes and the like, so as to realize a self-checkout in conjunction with mobile payments. If the products within the viewing angle of the image capturing device 126 fail to show enough features of the products (e.g., the products are not placed correctly, or the products are stacked up on top of each other), the product identification device 120 can automatically detect such situation and display/project a prompt of “Please turn over or separate the products” through the monitor or the projector. After the products are turned over or separated by the customer, the product identification may be completed. The prompt may use any prompt content that can draw attentions (e.g., colors or texts) to remind the customer.

The computer vision based product identification technology used in the computer vision based self-checkout system is characterized by its capability of interacting with customers so the checkout can be completed smoothly. In an exemplary example, after the products are placed by the customer, the products may be detected by identifying a gesture of the customer through the camera or the camcorder, or whether the customer is close to a checkout counter may be determined through, for example, infrared ray, ultrasonic wave or microwave sensors. During the product identification, serial numbers of the products may be projected onto the products, and the serial numbers of the names of the products may be displayed on the display device 128 so the customer can know of the identified products. If the products are not placed correctly, the customer will be prompted to place the product correctly, and the gesture of the customer will then be identified to start detecting the products again. If the self-checkout system 100 detects that there are still products in hands of the customer without being placed on the platform, the self-checkout system 100 will remind the customer to place the products.

An abnormal checkout behavior determination technology used in the computer vision based self-checkout system includes an abnormal checkout behavior determination and reminder; an active determination for situations like the objects held by the customer not all being placed into the checkout area, the weight of the product not matching the identification result and/or operation errors caused by the customer; and messages that prompt the staff to actively provide assistant for those situations. Modules involved with the abnormal checkout behavior determination technology may include a real-time keypoint detection technology module, a behavior/posture identification technology module, a handheld object identification technology module and the like, which will be described in details as follows.

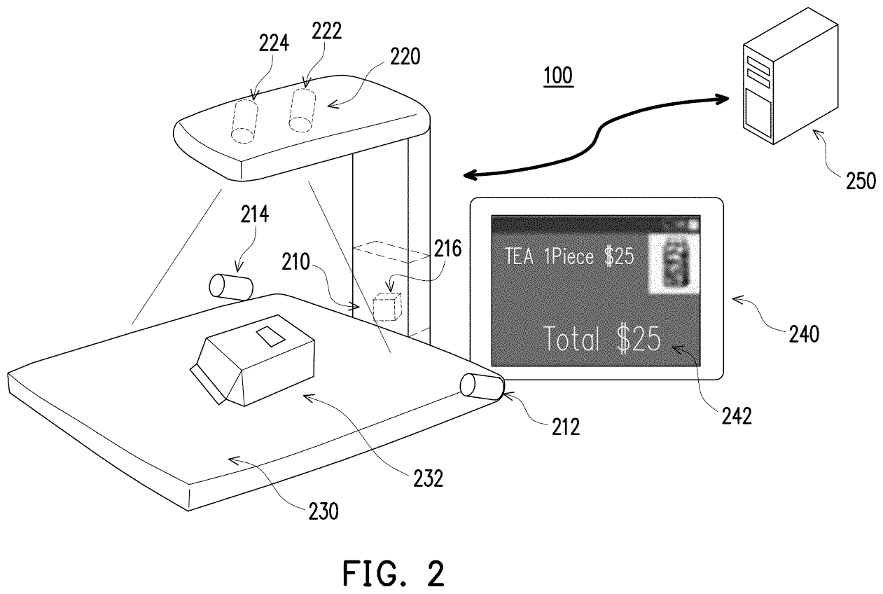

With reference to FIG. 2, FIG. 2 is a schematic structural diagram illustrating a self-checkout system in one of the embodiments of the disclosure. In this embodiment, a self-checkout system 100 includes a customer abnormal behavior detection device 210, a product identification device 220 and a platform 230. A clearly visible checkout area 232 is included on the platform 230 for the customer to place the products. Locations of the customer abnormal behavior detection device 210 and the product identification device 220 are for illustrative purposes only, and may be any locations on the schematic diagram 100.

In a practical application example, in order to obtain the image of the customer (customer image), the customer abnormal behavior detection device 210 may include image capturing devices 212 and 214 on both sides. Further, the locations of the two image capturing devices 212 and 214 may be adjusted based on demands instead of being limited to the locations in the drawing. The image capturing devices 212 and 214 are used to capture a customer image in front of the platform 230. The customer abnormal behavior detection device 210 is configured to perform an abnormal checkout behavior detection based on the customer image to obtain an abnormal behavior detection result. When determining that the abnormal behavior detection result is an abnormal behavior, an abnormal behavior notification is sent to thereby adjust the abnormal behavior.

The product identification device 220 may include an image capturing device 222 and a projection apparatus 224. This projection apparatus 224 may, for example, project the serial numbers of the products onto the products, and the display may display the serial numbers and the names of the products so the customer can know the identified products. In addition, if the products are not placed correctly, the customer may also be prompted to place the products correctly through projection, and the gesture of the customer may then be identified to start detecting the products again. The locations of the image capturing devices 212 and 214, the image capturing device 222 or the projection apparatus 224 may all be adjusted and may be shared and used by the others based on the demands. This is to say, for example, the customer abnormal behavior detection device 210 or the product identification device 220 can commonly drive and use aforesaid devices to accomplish the required operations.

In an embodiment, the self-checkout system 100 may include a display device 240, which can interact with the customer through a display content 242, and can also communicate with the customer through a touch panel of the display device 240. In an embodiment, the self-checkout system 100 may communicate with an external server host 250 through the network access device. In the above embodiment, a plurality or some of databases of the customer abnormal behavior detection device 210 or the product identification device 220 may be stored in the remote server host 250 or a cloud server (not shown).

In another exemplary example, as shown by FIG. 2, the self-checkout system 100 may include at least one processor 216, a plurality of image capturing devices 212, 214 and 222, a projection apparatus 224, a storage device (not shown) and a display device 240. The processor 216 is used to execute a customer abnormal behavior detection module and a product identification module. The customer abnormal behavior detection module and the product identification module are a program set or software stored in the storage device.

In an exemplary example, the function of the customer abnormal behavior detection module includes an abnormal checkout behavior determination and reminder; an active determination for situations like the objects held by the customer not all being placed into the checkout area, the weight of the product not matching the identification result and/or operation errors caused by the customer; messages that prompt the staff to actively provide assistant for those situations. In other words, the functional modules described above may have different combinations based on different requirements. Modules involved with the abnormal checkout behavior determination technology may include a part of all of the real-time keypoint detection module, the behavior/posture identification technology module, the handheld object identification technology module and the like.

In an exemplary example, the function of the product identification module includes detecting the features of the products on the platform through the computer vision and deep learning technology, identifying the names and the quantities of the product purchasing by the customer through the joint decision based on the features of the products including shapes, colors, texts, trademarks, barcodes and the like, and realizing the self-checkout in conjunction with mobile payments. If the products within the viewing angle of the camera fail to show enough features of the products (e.g., the products are not placed correctly, or the products are stacked up on top of each other), the identification system can automatically detect such situation and project the prompt of “Please turn over or separate the products” through the projector. After the products are turned over or separated by the customer, the product identification may be completed. The prompt may use any prompt content that can draw attentions (e.g., colors or texts) to remind the customer.

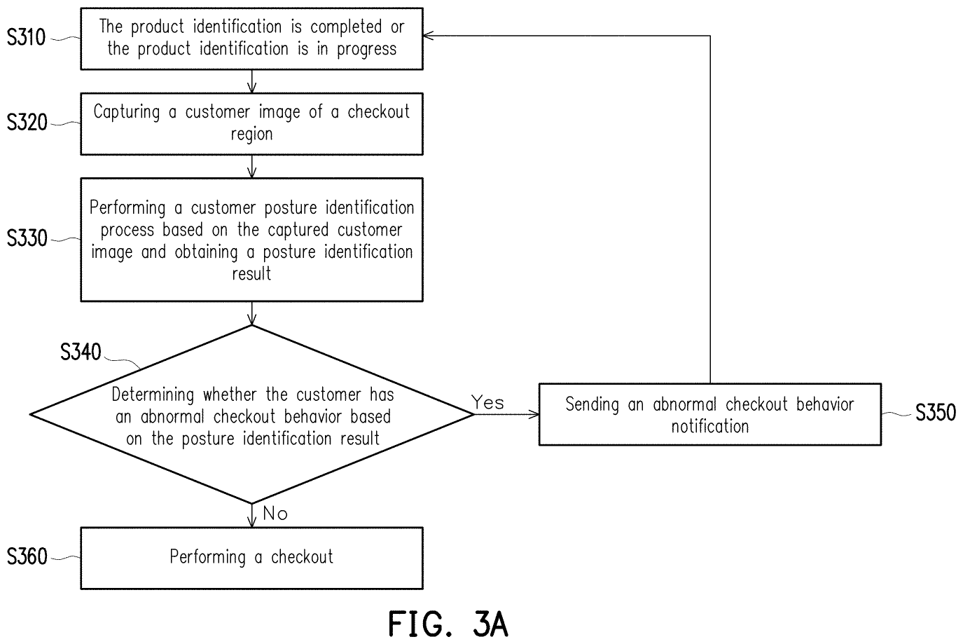

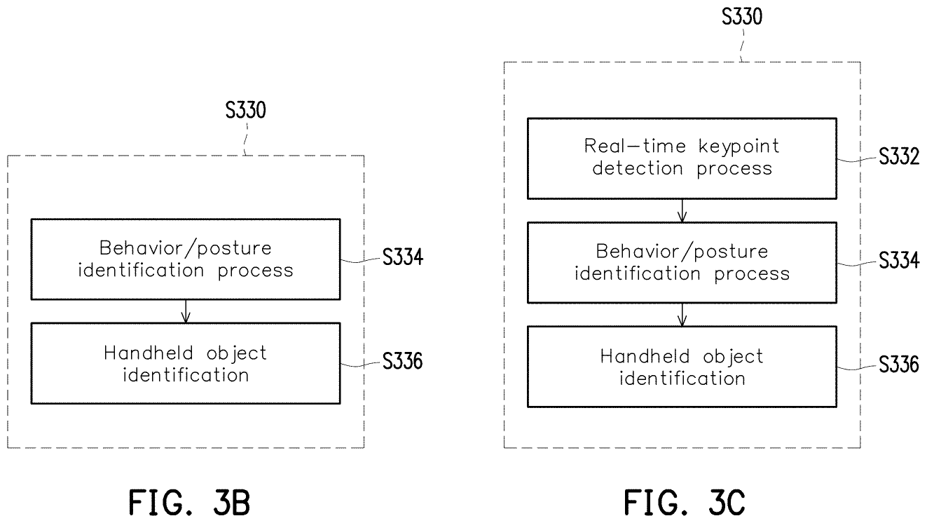

According to one embodiment of the disclosure, an operational process of the customer abnormal behavior detection device 210 in the self-checkout system is described as follows. With reference to FIG. 3A, FIG. 3A is a schematic diagram illustrating a customer abnormal behavior detection process in an embodiment of the disclosure. After step S310 in which the product identification is completed or the product identification is in progress, step S320 is performed to capture a customer image of a checkout region. Next, in step S330, a customer posture identification process is performed based on the captured customer image and a posture identification result is obtained. Then, in step S340, whether the customer has an abnormal checkout behavior is determined based on the posture identification result. If it is determined that the customer has the abnormal checkout behavior in step S340, step S350 is performed to send an abnormal checkout behavior notification. If it is determined that the customer does not have the abnormal checkout behavior in step S340, step S360 is performed to perform a checkout.

With reference to FIGS. 3B to 3C, FIGS. 3B to 3C are schematic diagrams respectively illustrating the customer posture identification process performed based on the customer image in an exemplary example of the disclosure, which refers to step S330 in the operational process of the customer abnormal behavior detection device 210. The customer posture identification process performed based on the customer image may adopt the process including a behavior/posture identification process S344 and a handheld object identification process S336 to obtain the posture identification result, as shown in FIG. 3B. In another embodiment, as shown by FIG. 3C, a real-time keypoint detection process S332 may be performed before performing the behavior/posture identification process S344 and the handheld object identification process S336 to obtain the posture identification result.

With reference to FIG. 3D, in one embodiment, the real-time keypoint detection process S332 includes performing a real-time keypoint detection module. The real-time keypoint detection module may use some real-time human pose estimation technology, for example, the “Realtime multiperson 2D pose estimation using part affinity fields” by Z. Cao, T. Simon, S.-E. Wei, and Y. Sheikh In CVPR, Jul. 8, 2017. The real-time keypoint detection process S332 includes using a customer image 361 being captured as input to a -two-branch convolutional neural network (CNN). As shown in FIG. 3D, the customer image 361 is input to a first branch and a second branch. After a two-stage computation, a confidence map of a body part detection and a part affinity field may be predicted and used for obtaining a part association. The part affinity field is one 2D vector region for encoding a position and an orientation of limbs on image domain. A two-branch model may be trained through image markers of the body part detection and the part affinity field. In a 2-branch multi-stage CNN architecture, a prediction for a confidence map St is made at a phase t in the first branch, and a prediction for PAFs Lt is made at a phase t in the second branch. After each stage, the predictions from the two branches and the image features are joined together in the next phase before performing the prediction of the next phase. Real-time keypoint information may be obtained based on the process described above.

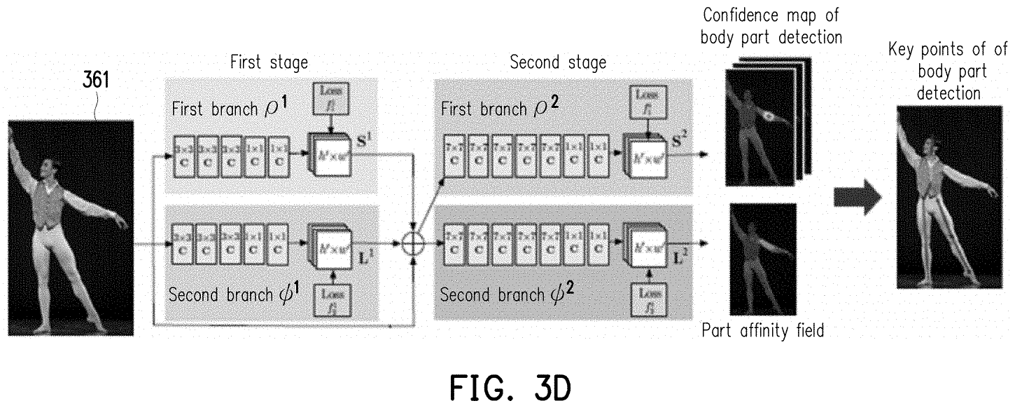

The behavior/posture identification process and the handheld object identification process described above may refer to FIG. 4A and FIG. 4B with reference to the description for FIG. 3B or 3C. With reference to FIG. 4A, a behavior/posture identification (a human pose identification) module is executed in this embodiment. Further, FIG. 4B illustrates five common checkout postures. First of all, based on a customer image 410 being captured, after key points of the human body are detected (e.g., step S332), a behavior of a monitored person is identified based on the key points at shoulders, elbows and wrists (e.g., step S334, referring to a key point line 412 of shoulders, elbows and wrists in FIG. 4A). After the human pose identification, a candidate region 414 in the image is retrieved for detecting handheld objects. Then, according to such an architecture, within this range, a YOLO algorithm (e.g., step 416) is used as a method for the object detector to locate an object and identify an object type, so as to perform a palm/handheld product detection and identification (step S336). YOLO refers to “You Only Look Once”, which may be used to identify the object. In an embodiment, simply by using a YOLO model to perform one CNN on the image, a category and a position of the object therein may be determined so an identification speed may be significantly improved. In this embodiment, by using the YOLO algorithm as a method for locating the object and identifying the object type, information regarding confidence indexes and bounding-boxes of five common checkout behaviors may be obtained to obtain a behavior/posture identification result 411. In the YOLO algorithm, the customer image 410 is segmented into a plurality of bounding-boxes. A location of each bounding-box in the customer image 410 is indicated by two coordinate points, for example, the coordinate point (x1, y1) at the top left corner and the coordinate point (x2, y2) at the right bottom corner, but not limited thereto, and a probability being which object is calculated for each bounding-box. Each bounding-box has five predication parameters, including x, y, w, h, and the confidence index. (x, y) indicates a shift from a center of the box, and w, h are length and width of the bounding-box, which can be indicated by using coordinate points (x1, y1) and (x2, y2). The confidence index contains the degree of confidence for the predicted object and accuracy for determining the object in the bounding box. This step can detect whether people are still carrying the products when using the self-checkout system. Five identified object types include, for example, R1: Cell phone, R2: Wallet, R3: Handbag, R4: Bottle or R5: Canned drink, as identification results used to identify whether the handheld objects are the products.

In this embodiment, how to detect the key points of the body in order obtain a human body posture category may refer to FIG. 4B, in which a checkout behavior of the monitored person is identified and a handheld product detection and identification is performed. With customer images 420 or 422 taken as an example, the bounding-boxes of the handheld objects may be marked by the behavior/posture identification module. After the keypoint detection and the behavior/posture identification, a range (e.g., junctions between hand, arm and body) is indicated as a region where the product and/or palm may appear. Then, based on the key point line 412 of shoulders, elbows and wrists and the candidate region 414 (a region marked by the dotted line) in the customer image, handheld products in different posture categories may then be determined. For example, postures 431 to 435 may be used to identify the human body posture category. For instance, the posture 431 and the key point line 412 of shoulders, elbows and wrists may be determined as a posture of “Carry object in one hand”. Then, the candidate region 414 (the region marked by the dotted line) in the customer image may be used to determine whether the handheld objects exist. Accordingly, the posture 431 may be classified into the human body posture category of “Carry object in one hand”. Also, the posture 432 may be classified into the human body posture category of “Carry object in both hands”. The posture 433 and the key point line 412 of shoulders, elbows and wrists may be determined as a posture of “Carry object in one hand and carry object under the shoulder of another hand”. Accordingly, the posture 433 may be classified into the human body posture category of “Carry object in one hand and carry object under the shoulder of another hand”. The posture 434 and the key point line 412 of shoulders, elbows and wrists may be determined as a posture of “Hands down”. The posture 435 refers to “Other pose”, which is also one of the five different posture categories. After a posture category of the monitored person is identified, the handheld product detection and identification may then be performed.

In an embodiment of the disclosure, whether the handheld objects are the products may be identified by using a palm tracking and handheld product detection to exclude personal belongs such as the leather bag, cell phone and the like. In detail, after a body keypoint detection, a body keypoint line is obtained, and then a plurality of nodes at shoulders, elbows and wrists (i.e., junctions between hand, arm and body) in the body keypoint line are identified. Then, the body keypoint line is compared with a preset model to obtain a handheld object posture category. For example, referring to the customer image 420 of the customer in FIG. 4B, according to the body keypoint line and line nodes, the person in the customer image 420 is most similar to the preset model “Carry object in one hand and carry object under the shoulder of another hand”. Therefore, it is determined that, most likely, the customer is carrying the product in one hand and carrying another object that is sandwiched under the shoulder of another hand. Then, a step for indicating handheld object candidate region is performed so the identification can be performed by using a behavior and posture identification technique to determine, for example, end nodes in the body keypoint line (indicating positions of the hands). In this way, a range of a right hand candidate region may be indicated to include one of the end nodes and the nodes at the shoulder and elbow where the object can be held in the body keypoint line, and a range of a left hand candidate region may be indicated to include another one of the end nodes and the node at the wrist in the body keypoint line. After the handheld object candidate region is indicated, whether an object is in the handheld object candidate region may be determined. In an embodiment, if it is determined that the object is in the handheld object candidate region, whether the object in the handheld object candidate region is the product may then be identified.

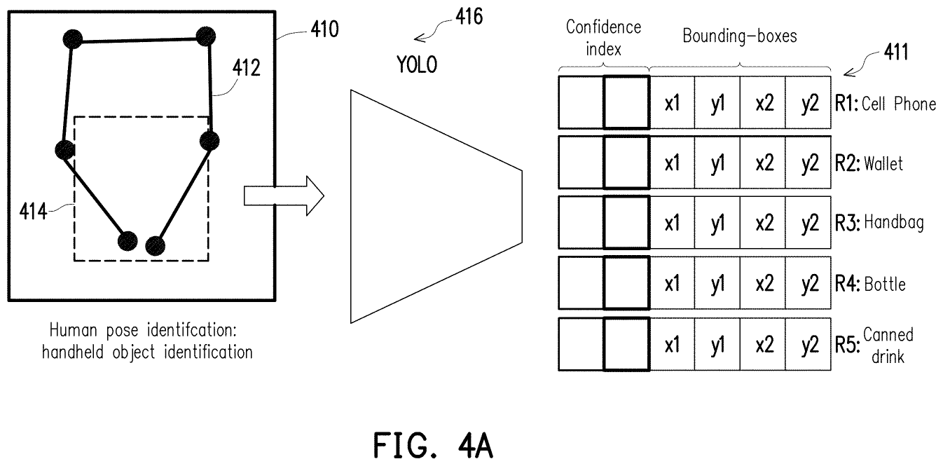

With reference to FIG. 5, FIG. 5 is a schematic diagram illustrating a computer vision based product identification process proposed by an embodiment of the disclosure. Here, the computer vision based product identification process at least includes a product image feature identification process and a product image feature identification analysis. In this embodiment, the product identification device 220 can store different applications or required data or software programs for communicating with the external server host 250 or the cloud server (not shown) that can be accessed through the network access device. The programs for the product identification device 220 of the present embodiment to operate includes, for example, a part or all of the product object segmentation program, the product feature identification program, the product placement determination program, the product facing direction determination program and/or the product connection detection program.

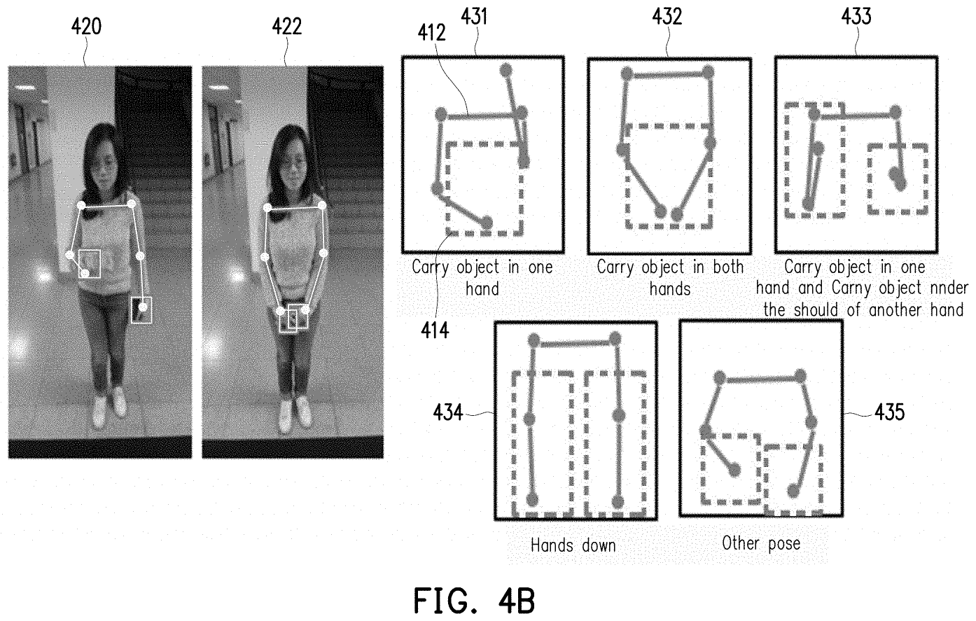

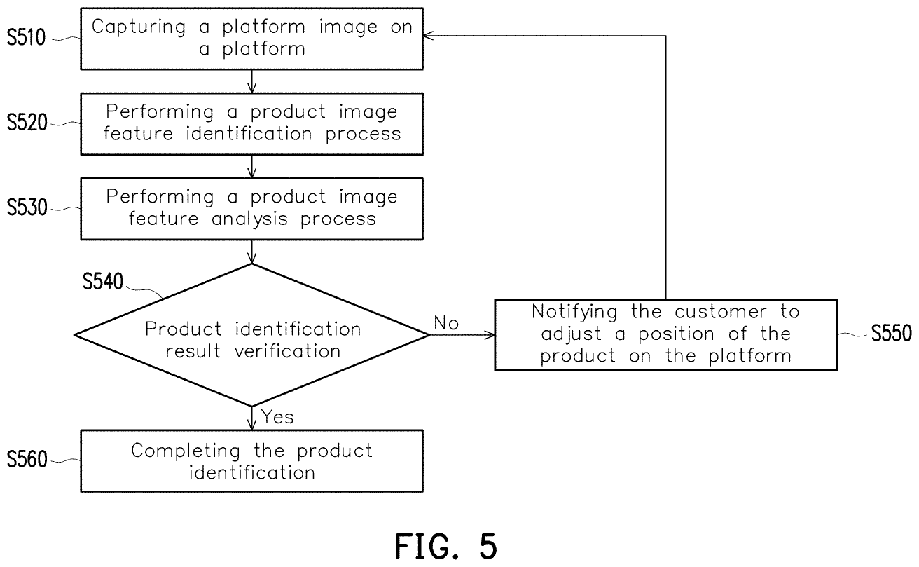

In step S510, the product identification device starts operating and captures a platform image on the platform 230 through the image capturing device 222. In step S520, the product image feature identification process is performed. In an embodiment, the processor 216 loads the product object segmentation program stored in the storage device into a memory device, and executes the product object segmentation program to segment a product image from the platform image, identify and capture product image features, such as a shape, a color distribution, a text, a trademark position or content. In an embodiment, because a plurality of products is placed on the platform 230, the captured platform image includes the plurality of products, and the image feature recognition process may include segmenting images of the plurality of products. The processor 216 loads the product object segmentation program stored in the storage device into the memory device, and executes the product object segmentation program to segment the captured platform image and find the product image for each product. In an embodiment, a product object segmentation process is used to obtain the product image for each product by, for example, segmenting a plurality of product regions from the platform image by an edge detection. The product object segmentation process will be described later below, with reference to FIGS. 6A and 6B. After the product image is captured, the product image features are identified based on the product image for subsequent comparison and analysis.

After the product image features are identified, a product image feature analysis process is performed based on those features, as shown by step S530. In step S530, the obtained product image feature (e.g., the shape, the color distribution, the text, the trademark, a barcode position or content) are compared with a feature database, so as to perform a product image identification operation. For example, the names and the quantities of the products purchasing by the customer may be analyzed according to the feature database that is already established.

In step S540, a product identification result verification is performed. In an embodiment, whether the product to be identified in the product image is corresponding to the product in the database is determined by, for example, determining whether the product image features of the product to be identified are corresponding to image features of the product stored in the feature database. If the product image features of the product to be identified are corresponding to the image features of the product in the feature database, it is then determined that the product in the product image is the product in the feature database, and step S560 is performed to complete the production identification. In an embodiment, if it is determined that the product image features are not corresponding to the image features of the product in the feature database, or it is unable to determine whether the product image features of the product to be identified are the image features of the product in the feature database, step S550 is performed, so that the customer is notified to adjust a position of the product on the platform. Then, the process returns to step S510, in which a platform image with the adjusted product on the platform is captured. In an embodiment, in step S540, if there are multiple products being identified and at least one of the identified products cannot be determined to be one of the products in the feature database, step S550 is then preformed.

The image feature recognition process in step S520 is described in detail in the following embodiment. In an embodiment, first, the image is first processed (e.g., by segmenting a captured product image), and then features of the product image are captured. With reference to FIGS. 6A and 6B, FIGS. 6A and 6B are schematic diagrams respectively illustrating a product object image segmentation process proposed by an embodiment of the disclosure. In FIG. 6A, based on a platform image 610 being captured, the product object segmentation program segments the product regions from the platform image 610 by the edge detection, increases a contrast between the background and the product based on a brightness feature in the platform image 610, locates a boundary of the product by a using edge detection method such as Sobel edge detection method, uses a run length algorithm to reinforce the boundary and suppress noises, and then segments the product regions after the boundary is determined. With reference to FIG. 6B, after the boundary of the product regions is determined, as shown in the converted platform image 620, coordinates of the product regions can be calculated to obtain a region where the product images exist so that the features of the product images can be located based on the region of the product images. Then, based on these features, the product image feature analysis process of step S530 is performed.

In step S530, the captured product image features may be used to analyze the names and the quantities of the products purchasing by the customer with reference to the already established feature database. FIG. 6C is a schematic diagram illustrating a product feature identification proposed by an embodiment of the disclosure. In an embodiment, for example, aforesaid object segmentation program may be performed to obtain the product image features. Afterwards, the processor 216 loads the product feature identification program stored in the storage device into the memory device, executes the product feature identification program to detect a plurality of features in the product regions by using deep learning or other algorithms, and performs the identification to obtain a plurality of product identification results based on the features. In an embodiment, by detecting the features of the product regions, using a deep learning technology to perform a product rotation and image viewing angle identification, and then extracting overall features (e.g., the shape and the color distribution) and detailed features (e.g., the text and the trademark) from the image in high-resolution, the products purchasing by the customer may be identified (e.g., different products 630 to 660 shown in FIG. 6C).

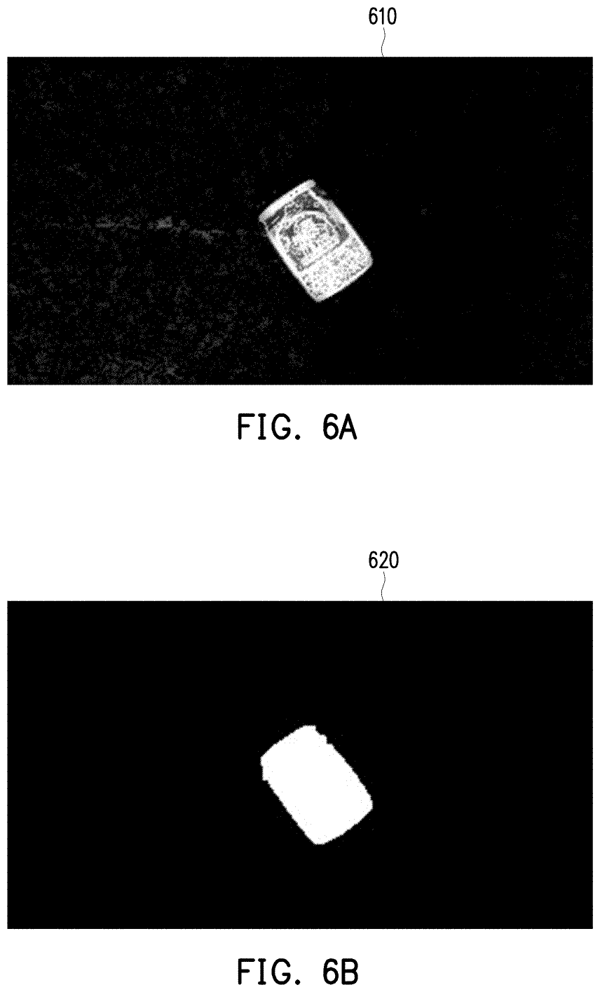

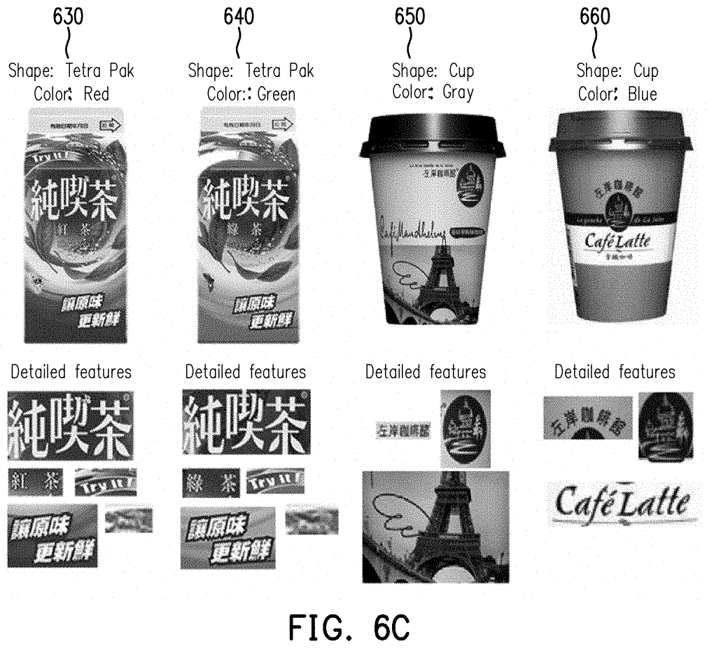

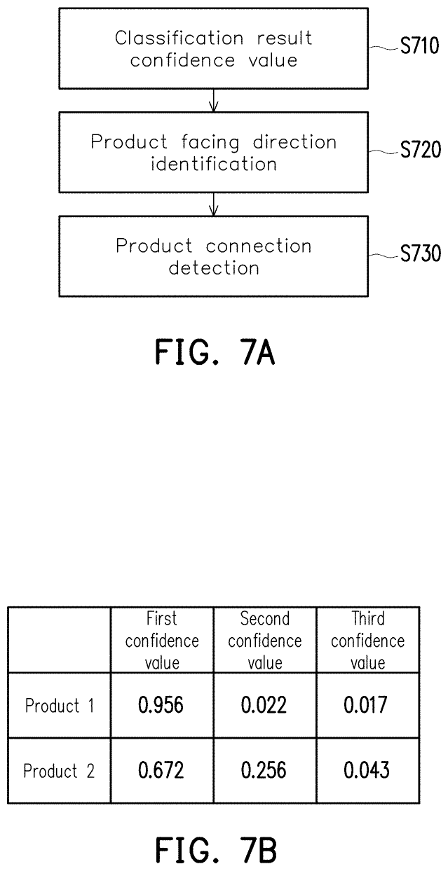

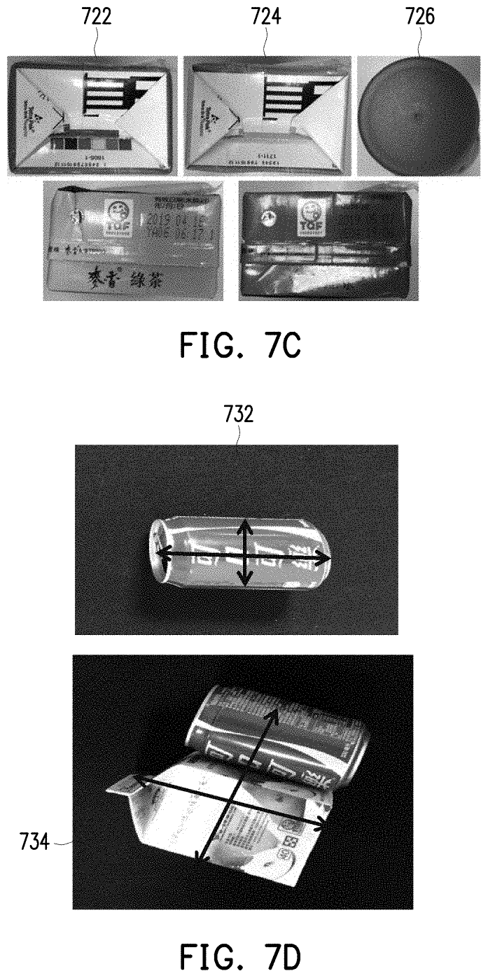

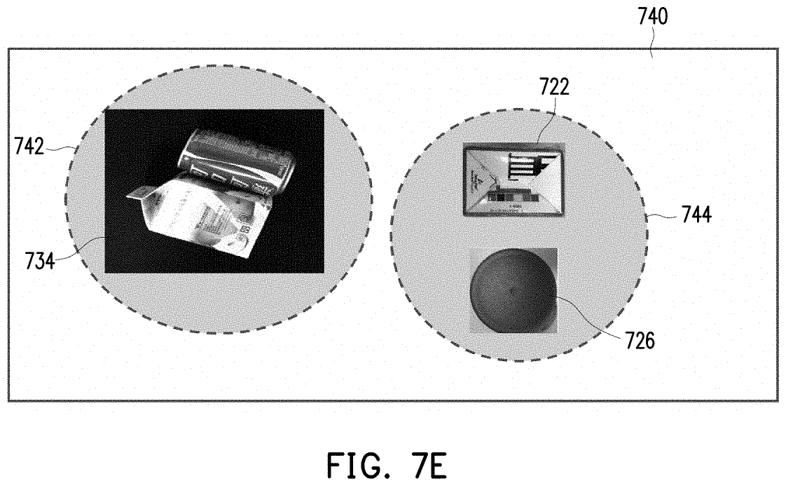

In an embodiment of the disclosure, the product classification may be performed in the product image feature analysis process in step S530. The processor 216 loads a product classification program stored in the storage device into the memory device and executes a product classification process. With reference to FIG. 7A, FIG. 7A is a schematic diagram illustrating the product classification process according to an embodiment of the disclosure. This classification process includes a step of setting a classification result confidence value (step S710), a step of a product facing direction identification (step S720) and a step of a product connection detection (step S730).

First of all, in step S710, the classification result confidence value is generated first. With reference to FIG. 7B, FIG. 7B is a schematic diagram illustrating a classification result confidence value table according to an embodiment of the disclosure. The product classification program calculates the classification result confidence value of the product classification based on the product image features. For example, based on the product image features, it can be calculated that, three highest classification result confidence values for the possibility of being Product 1 are 0.956, 0.022 and 0.017, and three highest classification result confidence values for the possibility of being Product 2 are 0.672, 0.256 and 0.043. In this way, the classification result confidence value table may be generated as shown in FIG. 7B, and whether a confidence level is high may then be determined according to the classification result confidence value. For example, whether the classification result confidence value is greater than a threshold may be determined, and the confidence level is high if it is determined that the classification result confidence value is greater than the threshold. Taken FIG. 7B as an example, if the threshold is 0.7, because the highest classification result confidence value for the possibility of being Product 1 is 0.956, it can be determined that the product image feature is Product 1. In an embodiment, when the classification result confidence value indicates that the confidence level is high or the product may be determined based on the classification result confidence value, it is not required to perform step S720 subsequently. If the classification result confidence value is less than the threshold, step S720 is then performed.

In step S720, the product facing direction identification is performed. In an embodiment of the disclosure, after executing the product feature identification program, the processor loads the product placement determination program stored in storage device into the memory device for execution. The product placement determination program is used to determine whether the object placed on the platform is the product, whether a surface of the product placed on the platform facing up is a surface with fewer features, or whether the product is placed in such a way that clear features can be captured by the image capture unit of the platform.

With reference to FIG. 7C, FIG. 7C is a schematic diagram illustrating a product facing direction determination process for determining a facing direction of the product proposed by an embodiment of the disclosure. Referring to step S720 and FIG. 7A and FIG. 7C, the product placement determination program can determine the facing direction of the product placed on the platform. For example, the deep learning technology may be used to perform an image identification, so as to determine whether the captured product image has the surface with fewer features, such as a top surface 722 of Tetra Pak, a bottom surface 724 of Tetra Pak, or a cap surface 726 of the bottle. If it is determined that a number of the features of the product facing up image is insufficient or too small, it is then determined that the product image has the surface with fewer features so the product cannot/is hard to be identified properly. In an embodiment, when it is determined that the product image has the surface with fewer features (i.e., the number of the features is insufficient for identification), it is not required to perform step S730 but to have the customer notified to adjust the facing direction of the product being placed.

With reference to FIG. 7D, FIG. 7D is a schematic diagram illustrating a product connection detection according to an embodiment of the disclosure. Referring to FIG. 7A and FIG. 7D together, with a bottle 732 of FIG. 7D as an example, after the product facing direction determination program is executed, if it is determined that the number of the features on the surface of the product facing up is sufficient, it may be determined that the product is lying flat on the platform. Next, the processor loads the product connection detection program stored in the storage device into the memory device for execution, so as to perform the step S730 of the product connection detection. The product connection detection program is used to determine whether multiple products are connected to each other or overlapping with each other through an aspect ratio detection. For example, if the aspect ratio of a normal (or the database's) canned drink is 2:1, when it is identified that the canned drink is lying and the aspect ratio of the canned drink is 1:1, it can be determined that the canned drink is connected to another product. In an embodiment, the prompt message may be sent to notify the customer to adjust the positions of the products.

With reference to FIG. 7E, FIG. 7E is a schematic diagram illustrating how the customer is prompted to adjust a placement manner of the product according to an embodiment of the disclosure. In this embodiment, a prompt of “Please place the products correctly on the platform” may be projected by the projector or other prompts including voice, text on a screen, etc., may be used to ask the customer to place the products correctly on the platform so that the product identification program may be re-executed. The prompt message can remind the customer by using prompts such as sounds, graphics, colors, texts, barcodes, and the like.

In another exemplary example, the prompt message for prompting the customer to adjust the placement manner of the product can project marks in different colors onto a platform 740 by using the projector. For example, a light ray in a first color (which is different from colors in different regions on the platform 740) may be projected onto a product 734 to generate a first color region 742. Meanwhile, a light ray in a second color (which is different from the first color and the colors in different regions on the platform 740) may be projected onto products 722 and 726 to generate a second color region 744. In this way, the customer can clearly know which products need to be adjusted. In addition to this embodiment, a message for prompting the customer to adjust a product placement position may be further provided to ask the customer to turn over or separate the products by, for example, using the prompt of “Please turn over and separate the products” projected by the projector as well as using other prompts including voice, text on a screen, etc. After that, the product identification program may be re-executed. The prompt message can remind the customer by using the prompts such as sounds, graphics, colors, texts, and the like.

In summary, an embodiment of the disclosure relates to a computer vision and deep learning for detecting the features in the product regions and identifying the names and the quantities of the products purchasing by the customer. If the products within the viewing angle of the camera fail to show enough product features, the prompts including sounds, graphics, colors, texts, etc. may be used to remind the customer to turn over and separate the products. As for the abnormal checkout behavior detection, after the behavior of the monitored person is identified based on the key points at shoulders, elbows and wrists through the real-time keypoint detection process, the handheld object detection may be performed, and then the prompts including sounds, graphics, colors, texts, etc., may be used to remind the customer to place the products correctly before the step of the product identification is performed again.

An embodiment of the disclosure proposes a self-checkout system and a method thereof, including the product identification and functions for determining customer abnormal behavior. The self-checkout system includes a product identification function and a customer abnormal behavior detection function. The product identification function is configured to perform a product identification, in which whether products are correctly placed on a platform and whether the identification can be completed are determined. The customer abnormal behavior detection function is configured to detect whether a customer has an abnormal checkout behavior.

According to an embodiment of the disclosure, the self-checkout system and method thereof can instantly identify the names and the quantities of the products purchasing by the customer, realize a self-checkout in conjunction with mobile payments, and reduce a theft rate. Based on the above, the self-checkout system and the method thereof can identify the names and the quantities of the products purchasing by the customer. Especially, whether a placement manner of the products can show enough features of the products within a viewing angle of a camera may be determined, and the customer may be prompted to turn over or separate the products in order to complete identifying the products. In addition, an embodiment of the disclosure can also identify the abnormal checkout behavior by performing a skeleton and behavior pattern identification and the handheld product detection, and can determine whether the customer is still carrying the products after excluding personal belongs such as the leather bag, the cell phone and the like.

Although the disclosure has been described with reference to the above embodiments, it will be apparent to one of ordinary skill in the art that modifications to the described embodiments may be made without departing from the spirit of the present disclosure. Accordingly, the scope of the present disclosure will be defined by the attached claims and not by the above detailed descriptions.

It will be apparent to those skilled in the art that various modifications and variations can be made to the disclosed embodiments. It is intended that the specification and examples be considered as exemplary only, with a true scope of the present disclosure being indicated by the following claims and their equivalents.

1. A self-checkout system, comprising:
a platform, configured to place at least one product;
a product identification device, configured to perform a product identification on the at least one product placed on the platform; and
a customer abnormal behavior detection device, configured to perform an abnormal checkout behavior detection based on a customer image captured in front of the platform to obtain an abnormal behavior detection result, wherein when determining that the abnormal behavior detection result is an abnormal behavior, an abnormal behavior notification is sent to thereby adjust the abnormal behavior.

2. The self-checkout system according to claim 1, wherein the customer abnormal behavior detection device comprises:
at least one image capturing unit, configured to capture the customer image; and
a processor, configured to perform the abnormal checkout behavior detection on the customer image to obtain the abnormal behavior detection result,
wherein the abnormal checkout behavior detection comprises performing a posture identification process to detect a checkout posture in the customer image, and then performing a handheld object identification process on a region based on the checkout posture to obtain the abnormal behavior detection result.

3. The self-checkout system according to claim 2, wherein before performing the posture identification process, the processor of the customer abnormal behavior detection device performs a real-time keypoint detection process on the customer image to obtain keypoint information of a customer in the customer image for performing the posture identification process.

4. The self-checkout system according to claim 3, wherein the processor is configured to obtain a body keypoint line of the customer from the customer image, and comparing the body keypoint line with a preset model to obtain the keypoint information.

5. The self-checkout system according to claim 2, wherein the processor of the customer abnormal behavior detection device is configured to obtain a plurality of key points in the customer image, and compare a key point line formed by the key points with a preset model to obtain the checkout posture corresponding to a customer.

6. The self-checkout system according to claim 5, wherein the processor of the customer abnormal behavior detection device further obtains a human body posture category based on the checkout posture, and determines a position and a range of a handheld object candidate region for performing the handheld object identification process.

7. The self-checkout system according to claim 1, wherein the product identification device performs the product identification on the at least one product placed on the platform to obtain an identification result, wherein if the identification result is not obtained, a prompt notification is sent for adjusting a placement manner of the at least one product on the platform.

8. The self-checkout system according to claim 1, wherein the product identification device is configured to start to perform the product identification by identifying a customer gesture in the customer image through a camera, or is configured to start to perform the product identification by determining whether a customer is close to the platform through an infrared ray sensing, an ultrasonic wave sensing or a microwave sensing.

9. The self-checkout system according to claim 1, wherein the product identification device is configured to project a serial number onto the at least one product.

10. The self-checkout system according to claim 7, wherein the product identification device comprises:
an image capturing unit, capturing a platform image of the at least one product placed on the platform; and
a processor, performing the product identification on the platform image to obtain a plurality of features corresponding to the at least one product, and performing a comparison with a product feature database based on the features to obtain the identification result.

11. The self-checkout system according to claim 10, wherein when the processor of the product identification device performs the product identification on the platform image to obtain the features corresponding to the at least one product for performing the comparison to obtain the identification result, if a number of the features is insufficient, the prompt notification is sent for adjusting the placement manner of the at least one product on the platform.

12. The self-checkout system according to claim 11, wherein the processor of the product identification device is configured to segment a plurality of product regions in the platform image by an edge detection, detect the features of the at least one product from the product regions, and identify the features of the at least one product.

13. The self-checkout system according to claim 12, wherein when performing the product identification on the platform image, the processor of the product identification device is configured to obtain a classification result confidence value by comparing the platform image with the product feature database, and obtain the identification result if the classification result confidence value is greater than a threshold.

14. A self-checkout method, comprising:
performing a product identification on at least one product placed on a platform;
capturing a customer image; and
performing an abnormal checkout behavior detection based on the customer image, and obtaining an abnormal behavior detection result based on the customer image, wherein
when determining that the abnormal behavior detection result is an abnormal behavior, an abnormal behavior notification is sent to thereby adjust the abnormal behavior.

15. The self-checkout method according to claim 14, wherein the abnormal checkout behavior detection comprises performing a posture identification process to detect a checkout posture in the customer image, and then performing a handheld object identification process on a region based on the checkout posture to obtain the abnormal behavior detection result.

16. The self-checkout method according to claim 15, wherein before the posture identification process, a real-time keypoint detection process is performed on the customer image to obtain keypoint information of a customer in the customer image for performing the posture identification process.

17. The self-checkout method according to claim 16, wherein the real-time keypoint detection process obtains a body keypoint line of the customer from the customer image, and compares the body keypoint line with a preset model to obtain the keypoint information.

18. The self-checkout method according to claim 15, wherein the handheld object identification process comprises obtaining a plurality of key points in the customer image, and comparing a key point line formed by the key points with a preset model to obtain the checkout posture corresponding to a customer.

19. The self-checkout method according to claim 18, wherein a position and a range of a handheld object candidate region are further determined based on the checkout posture for performing the handheld object identification process.

20. The self-checkout method according to claim 14, further comprising capturing a platform image of the at least one product on the platform, obtaining an identification result based on the platform image, and sending a prompt notification for adjusting a placement manner of the at least one product when the identification result is not obtained.

21. The self-checkout method according to claim 14, further comprising starting to perform the product identification by identifying a customer gesture in the customer image, or starting to perform the product identification by determining whether a customer is close to the platform through an infrared ray sensing, an ultrasonic wave sensing or a microwave sensing.

22. The self-checkout method according to claim 14, further comprising projecting a serial number onto the at least one product.

23. The self-checkout method according to claim 20, wherein the product identification comprises obtaining a plurality of features corresponding to the at least one product based on the platform image, and performing a comparison with a product feature database based on the features to obtain the identification result.

24. The self-checkout method according to claim 23, wherein when performing the product identification on the platform image to obtain the features corresponding to the at least one product for performing the comparison to obtain the identification result, if a number of the features is in insufficient, sending the prompt notification for adjusting the placement manner of the at least one product on the platform.

25. The self-checkout method according to claim 24, wherein the step of performing the product identification on the platform image to obtain the feature corresponding to the at least one product comprises
segmenting a plurality of product regions in the platform image by an edge detection,
detecting the features of the at least one product from the product regions, and
identifying the features of the at least one product.

26. The self-checkout method according to claim 25, wherein when the product identification is performed on the platform image, the number of the features is obtained by
comparing the product regions segmented from the platform image with the product feature database to obtain a classification result confidence value; and
obtaining the identification result accordingly if the classification result confidence value is greater than a threshold.

27. A self-checkout device, comprising:
a platform, configured to place at least one product;
an image capturing device, configured to capture a platform image and a customer image; and
a processor, configured to perform a product identification process or an abnormal checkout behavior detection process on the at least one product placed on the platform,
wherein the product identification process comprises obtaining an identification result based on the platform image, wherein when the identification result is not obtained, a prompt notification is sent for adjusting a placement manner of the at least one product on the platform,
wherein the abnormal checkout behavior detection process performs an abnormal checkout behavior detection based on the customer image to obtain an abnormal behavior detection result, wherein when the abnormal behavior detection result is verified as an abnormal behavior, an abnormal behavior notification is sent to thereby adjust the abnormal behavior.

28. The self-checkout device according to claim 27, wherein the processor is configured to perform a product identification on the platform image to obtain a plurality of features corresponding to the at least one product, and perform a comparison with a product feature database based on the features to obtain the identification result.

29. The self-checkout device according to claim 28, wherein when the processor performs the product identification on the platform image to obtain the feature corresponding to the at least one product for performing the comparison to obtain identification result, if a number of the features is insufficient to obtain the identification result, the prompt notification is sent for adjusting the placement manner of the at least one product on the platform.

30. The self-checkout device according to claim 29, wherein the operation in which the processor is configured to perform the product identification on the platform image to obtain the feature corresponding to the at least one product comprises segmenting a plurality of product regions in the platform image by an edge detection, detecting the features of the at least one product from the product regions, and identifying the features of the at least one product.

31. The self-checkout device according to claim 30, wherein when the product identification is performed on the platform image, the number of the features is obtained by
comparing the product regions segmented from the platform image with the product feature database to obtain a classification result confidence value; and
obtaining the identification result accordingly if the classification result confidence value is greater than a threshold.

32. The self-checkout device according to claim 27, wherein the processor is configured to perform the abnormal checkout behavior detection on the customer image to obtain the abnormal behavior detection result, wherein the abnormal checkout behavior detection comprises performing a posture identification process to detect a checkout posture in the customer image, and then performing a handheld object identification process on a region based on the checkout posture to obtain the abnormal behavior detection result.

33. The self-checkout device according to claim 32, wherein before performing the posture identification process, the processor performs a real-time keypoint detection process on the customer image to obtain keypoint information of a customer in the customer image for performing the posture identification process.

34. The self-checkout device according to claim 33, wherein the processor is configured to obtain a body keypoint line of the customer from the customer image, and comparing the body keypoint line with a preset model to obtain the keypoint information.

35. The self-checkout device according to claim 34, wherein the processor is configured to obtain a plurality of key points in the customer image, and comparing a key point line formed by the key points with the preset model to obtain the checkout posture corresponding to the customer.

36. The self-checkout device according to claim 35, wherein the handheld object identification process performed by the processor further comprises obtaining a human body posture category, and determining a position and a range of a handheld object candidate region for performing the handheld object identification process.
